(19) United States
(12) Patent Application Publication
(10) Pub. No.: US 2009/0212160 A1
(43) Pub. Date: Aug. 27, 2009

(54) Method for producing lateral ejection apparattii for helicopter or plane

(76) Inventor: Michael Lawrence Beauchamp, San Francisco, CA (US)

Correspondence Address: Michael L. Beauchamp, # 501, 285 Turk St, San Francisco, CA, 94102, US

(21) Appl. No.: 11/827,146

(22) Filed: Sep. 17, 2007

Related U.S. Application Data
(60) Provisional application No. 60/830,426, filed on Jul. 13, 2006.

(51) Int. Cl. B64D 25/108

(52) U.S. Cl. 244/122 AG

(57) ABSTRACT

An aircraft fuselage, with a seat chassis mounted on a set of track and guide rails. Any ejection seat chassis with an occupant attached to a guide track is ejectable along a lateral trajectory, perpendicular to the horizontal longitudinal axis of an aircraft fuselage interior, and can be guided out of the field of an imperiled aircraft during ejection by a rocket catapult system. A seat, framework, bed or chassis is enabled to eject laterally from an aircraft fuselage since a conventional hinged door is operational within a greater sliding emergency door panel which pneumatic rockets at the top and bottom of the emergency sliding door transverse the greater emergency sliding door panel including an interior fixed conventional hinge operational door along a set of tracks attached to the frame and outer fuselage of said aircraft, out of the path of the lateral ejection seat chassis or chassis', towards the rear of an aircraft where the sliding greater panel is prevented from recoiling by spring loaded latch catches; and which emergency door can also drop-slide down by pneumatic rocket assist for some aircraft where the weight, time and spatial difference between a drop-down and a slide-back emergency door or exit opening can in many instances is a benefit to use a drop-down emergency door or exit, pneumatically propelled; so that an aircraft has less nascent drag from rocket weight, and can result in a fractionally quicker or faster rate of acceleration and removal of the door, panel or canopy from the lateral ejection pathway when feasible. Wing struts can also be removed from the emergency lateral ejection exit pathway by pneumatic or other explosive charge means. Additional supporting fuselage struts and slender tempered glass panes are constructed into the fuselage for increased rigidity for the enlarged fuselage structure incorporating a same near relative number of aircraft seats for pilots and passengers, equipped with lateral ejection apparattii, and has an improved field of view. Dual airbags for positioning the legs and torso of an occupant for a safe emergency exit lateral ejection are embedded or attached to a structure directly in front of a seat chassis. A second set of pressure sensitive airbags, head, neck, spine and organ concave-convex protector are attached on both sides of a seat chassis. Three compartments for altitude appropriate parachutes and a sensor fuse box for opening said desired chute are located inside an ejection seats rigid framework back section. The invention includes an interior side mounted blast shield which a rocket catapult systems rocket nozzles face, and which rocket or rockets are locked by collar seal(s) to a said blast shields, alloy or metallic, ceramic tile backing. A track support launcher platform, column, columns or center console support the lateral ejection apparattii at a functional and comfortable level and height for the occupant or occupants. Otherwise, the tracks or guide rails can be attached directly on an aircraft fuselage floor frame or attached to a wall frame structure in an aircraft fuselage, and can be constructed within rows with aisles on a chain motor reloading laterally aligned guide track for lateral rotor positioning lateral ejection apparattii.

### BACKGROUND OF THE INVENTION

1. Field of the Invention

The new invention relates to the method, process, devices or apparattii of aircraft, specifically improvements and advantages, which, allow for the first time all occupants of helicopters and planes to eject laterally and safely from a helicopter or plane.

2. Description of Prior Art

Until now the failing has been that aircraft occupant ejection was possible only on a horizontal-vertical and even longitudinal axis to the upright posture of a fighter jet as in military fighter jets, leaving most flying individuals and parties without access to a timely means of emergency exit in the event of a helicopter or plane failure. Clearly, it is inefficient and very dangerous, and improbable of success to attempt to eject vertically through the ceiling, past the rotor-blades of a helicopter or gyroplane by rocket catapult. Longitudinal ejection cannot provide for equal access to an emergency exit, because aircraft are built along the longitude, relegating the larger surface areas along the right and left latitudes of an aircraft fuselage as the sole reasonable, sound and safe areas for emergency exits of equal access in a commercial airliner or general aviation aircraft or other aircraft. Vertical ejection is inefficient from planes and poses a greater risk because of the greater forces required in most instances when vertically ejecting an aircraft seat or apparattii and occupant or occupants along the height of a planes interior depth through and into the counter acting forces of gravity. All ejection devices until now as cited in the references are void of the ability to laterally eject a plane aircraft occupant or helicopter aircraft occupant to safety, when said aircraft is in its upright posture or otherwise.

### SUMMARY OF THE INVENTION

The objects and advantages of the new invention provide a safe, stable and efficient process, methodology, devices and apparattii, whereby all occupants of aircraft, be they helicopters or planes, or, like action crossovers, such as gyroplanes or spacecraft designed to fly like planes, are laterally ejected from an imperiled and life threatening said aircraft. Accordingly, it is an object of this invention to provide laterally aligned escape devices for all types of private, business, commercial, government and general aviation aircraft, which lateral ejection apparattii are stable, reliable, simple, efficient, safe and effective at extracting aircraft occupants from life threatening aircraft, whether they are sitting in a seat or lying down in a bed. More specifically, this invention seeks to provide a method and process of escaping life threatening aircraft by rocket catapult propulsion and a unique multiple parachute configuration, with a gas powered rotor motor harness which is useful and effective, not just at moderate and tolerable altitudes, but during onboard fires, runway overshooting, very low or zero altitudes, or when over a body of water at a very low or tolerable altitude.

Still a further object is to extract pilots, passengers, emergency and medical patients in seats, beds or apparattii from life threatening aircraft by configuring rigid ejection apparattii framework perpendicular to aircraft longitudinal horizontal axis and propelling said occupant or occupants out the side of said aircraft by a rocket catapult system, past an emergency pneumatic rocket actuated sliding aircraft door or panel, wing strut, support or other object in the lateral ejection pathway, so then an automatic parachute system can deploy, lower or recover the laterally ejected occupant or occupants to the ground or surface.

Another object is to provide laterally ejectable apparattii which are aerodynamically able to navigate a life threatening aircraft debris field, by employing a track and guide rail construction of a monorail or monorails type, which uses a tubular airfoil form of monorail working as an airfoil or airfoils, i.e. wings, yaws, fins, flaps, rudders attached to the underside or underside and back of a lateral ejection apparattii, with air current flowing through the empty monorail track tube or tubes, insuring a steady and reliable emergence flight from said aircraft debris field.

Another object is to provide new aircraft fuselage structures, which are reinforced and/or enlarged, with fuselage struts and tempered glass panes, so that a reduced but relative number of aircraft seats or beds are still able to be installed in existing aircraft fuselage designs, while incorporating said lateral ejection apparattii, without weakening the fuselage structure or reducing or impinging a field of view in the aircraft fuselage, cabin or cockpit.

Another object is to make available, specifically, an ejection guide rail monorail roller truck and roller truck wheels construction, which is a fire resistant, self ventilating grid formation for ducting heat caused by fire or enemy fire, thereby said ventilating preventing or minimizing track freezing or similar failure of a guide track and rail system due to severe friction of metallic or alloy tracks, a track and guide rail expanding against one another from expose to very high temperatures.

Another object is to provide laterally ejecting apparattii at very low or zero altitudes, during aircraft fires, or water escape flotation, escapes that utilize a delayed seat, bed or apparattii separation from an occupant, using a gas powered rotor motor harness, so that the apparattii provides protective surfaces to the occupant as the laterally ejecting apparattii impacts the ground, water or other surface.

Another object is for not just doors and panels of aircraft to be removed by pneumatic means from the lateral ejection pathway, but all objects and instruments by pneumatic or other explosive charge means: wing struts and supports and other canopy like aircraft doors or panels can also be quickly cleared from the lateral ejection pathway.

Another object is to use teflon or other fire resistant material, primarily on the outer surface, but not limited to the outer surfaces of a seat or bed or apparattii right and left side mounted, pressure sensitive airbags, and roller truck wheels, and track mesh end cover to prevent fire or enemy fire from burning or hitting the ejected occupant or occupants, or igniting the guide track or igniting the roller truck wheels.

Another object is to minimize the lateral force on a spine, neck, head and organs of an occupant by either turning a seat or apparattii in a horizontal degree just prior to lateral ejection to reduce the vertical angle of the human body to the lateral force of the rocket catapult, or by using side mounted pressure sensitive airbags to create a rigid restraint and confine for the body, head, neck, spine and organs; or using any other bucket or concave form to restrain a human body during lateral ejection.

Another object to achieve is an advantageous arrangement combining the advantages of conventional jet aircraft vertically seeking ejection apparatus with the advantages of lateral ejection apparattii and process. When aircraft seats and their occupants can be aligned and usually are in commercial and private aircraft, along the edge of the planes right and left latitudes, and ejected laterally; thereby, when an aircraft is in an upright posture, minimizing both the applied force of gravity pulling down on the seat and seat occupant and the distance the apparatus transverses; so to be removed by the lateral ejection apparattii powered by a rocket catapult and moving from point A to point B along the same or near same gravitational plane as the aircraft, when ejected from a plane in a dangerous or life threatening descent; so that an automatic, individual parachute system comprised of a parachute, a base jumping or similar paragliding capable parachute, and a drag parachute which drag parachute and even a base and/or paragliding capable parachute(s) deploy during low or near zero altitude lateral ejections; can be automatically activated and deployed to break and stabilize the plane occupant(s) descent to a surface, after ejecting laterally from a plane. Subsequently, the weight or seat of an aircraft occupant is now placed on a set of tracks, rails or apparattii arranged perpendicular to the horizontal longitudinal axis of an aircraft and ejected by a rocket catapult system past the emergency sliding, fracturing or frangible door, panel, object or instrument removed from the path of the laterally ejecting seat and occupant by pneumatic or other explosive charge means for the first time. Separately falling seats and parachutists in seat rows aligned in aisles on a reloading chain and gas engine powered track and guide rail lateral ejection apparattii are also a useful construction of the invention for laterally ejecting aircraft occupants who are arranged in rows and aisles.

### BRIEF DESCRIPTION OF THE DRAWINGS

FIG. 1A, see FIG. 1.

FIG. 1B is a cutaway inside rear view of a single or double track lateral ejection apparatus for two side to side aircraft seats.

FIG. 1C is the oblique view of the lateral ejection bed's long track ends, and sleek, hidden rocket catapult system.

FIG. 1 is a transparent side view of the enlarged and reinforced aircraft fuselage, with two lateral ejection apparattii, with triple monorail tracks, mounted on the supporting track and launcher platform legs in which rotor positioning tail fins are slotted.

FIG. 2 is a side view of the reinforced and enlarged aircraft fuselage, with a closed fixed emergency greater sliding door panel, with an interior operational conventional hinge door.

FIG. 3 is a side view of the aircraft fuselage, and the fixed emergency greater sliding door panel with an interior operational conventional hinge door both transversing the aircraft fuselage by means of pneumatic rockets.

FIG. 4 is a side view of the path of the laterally ejecting seat chassis, or apparattii moving away from the upright aircraft fuselage.

FIG. 5 is a side view of two laterally ejected devices initiating parachute extraction.

FIG. 6 is a side view of the triangular triple monorail apparattii.

FIG. 7 is a side view of the triangular triple monorail outer track, guide track box.

FIG. 8 is a side view of the triple monorails after the outer track box has been ejected.

FIG. 9 is an anterior side perspective view of the triangular triple monorails arrangement, showing a blast shield, and three track support columns for three tracks.

FIG. 10 is a transparent elevated view of the back monorail track and guide rail.

FIG. 11 is a transparent elevated view of one of the two bottom positioned monorail tracks and guide rails.

FIG. 12 is an elevated view of the supporting track roller trucks and roller truck wheels.

FIG. 13 is an elevated view of a corner elbow supporting track roller trucks and roller truck wheels.

FIG. 14 is an elevated view of an aircraft seat with three parachute containers along the back and inside an ejection seat rigid framework.

FIG. 15 is an elevated transparent view of a hermetically sealed altitude appropriate parachute ignition sensor and fuse box.

### DETAILED DESCRIPTION OF THE INVENTION AND DRAWINGS

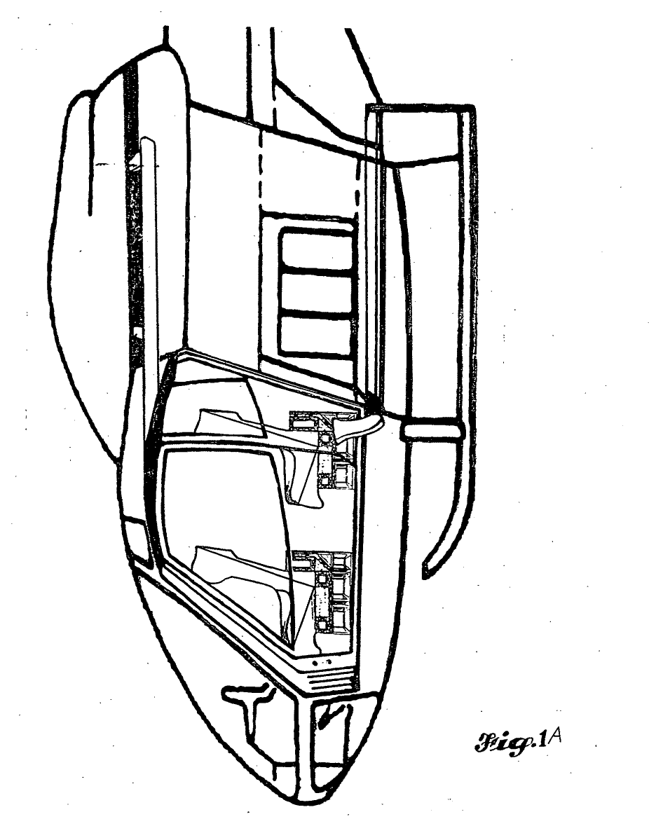

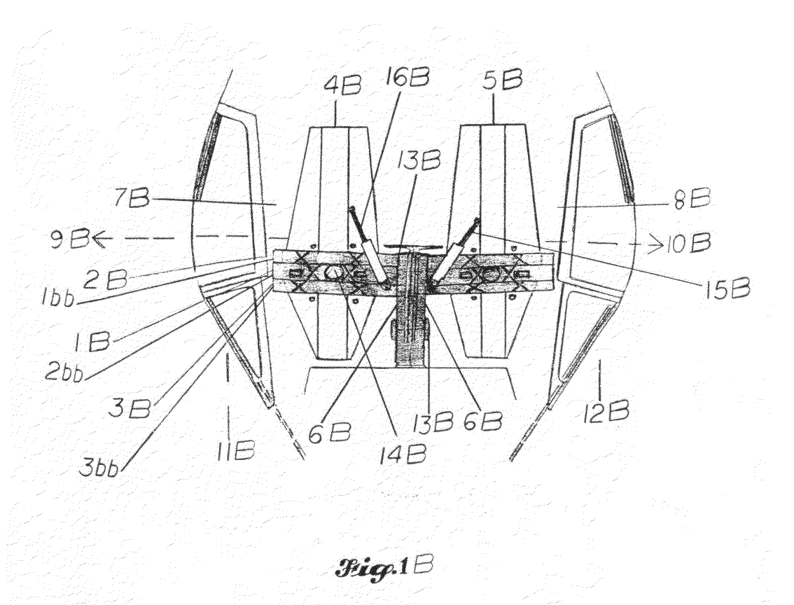

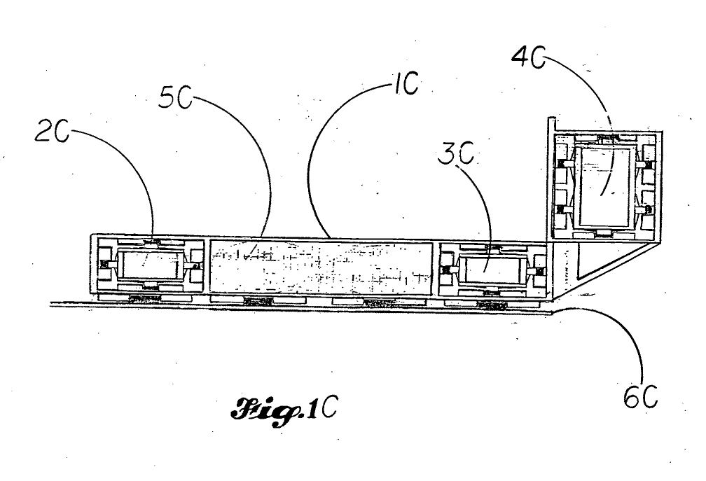

FIG. 1A, see FIG. 1.

FIG. 1B shows the rear view of a single 1B and/or double track 2B, and 3B, lateral ejection system with two side to side aircraft seats 4B, 5B, attached to a center console 6B, and with two aircraft door canopies 7B, 8B, which arrows 9B, 10B, 11B, 12B, show the right angle trajectory which aircraft doors are pneumatically rocketed, fractured or frangilized by explosive charge means at the onset of the lateral ejection sequence. In a single or double track construction, a number of rocket catapult chambers are used, which are correspondingly rocket catapult chambers, 1bb, 2bb and/or 3bb. Moreover the lateral ejection tool is sightable by utilizing an aiming mechanism FIG. 1B, directed by a mechanized gear console handle 13B, and swing arm barrel sight seat swivel 14B; only when existing fuselage area allows; actuated by cylindrical telescoping hydraulic arms 15B, and 16B, capable of realizing near perfect, or, perfect theoretical, lateral ejection respective of the real time forward motion (pressure) from velocity and position of a failed aircraft, by targeting preferred seat trajectories 9B, 10B, 11B, 12B, towards any quadrant within a sphere when right and left bipolar seat pairs FIG. 1B, are configured in a combat or high performance helicopter or plane; if said aiming mechanism operates independent of a robotic arm, which costs would perhaps become prohibitive except in luxury aircraft or military designs in an exemplary embodiment. The aiming mechanism can work by pushing and pulling the lateral ejection track and guide rail with attached seat chassis, swinging from a center console 13B, containing a ceramic tile with alloy backing blast shield, and a swivel plate 14B, on which a single track, double track or triple monorail track are attached without overburdening the aircraft with additional weight, including attached simply to an aircraft floor or wall frame structure without a center console, riser or launcher platform.

FIG. 1C shows a lateral ejection bed 1C, with three long, track ends 2C, 3C, 4C, in a triangular triple monorail track configuration and sleek, hidden rocket catapult system 5C, between the two bottom mounted monorail tracks; as well as a supporting track 6C.

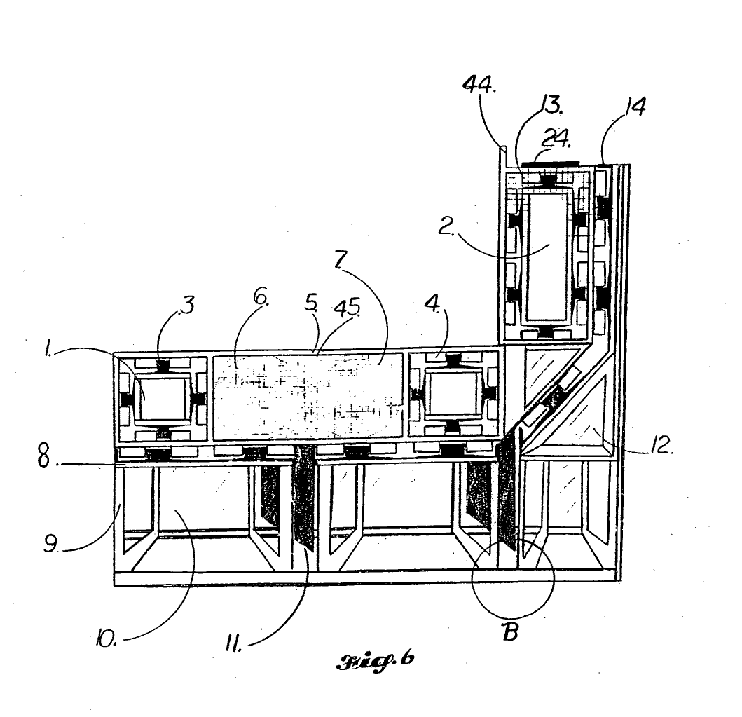

FIG. 1 shows an aircraft fuselage, having a cockpit, frame, door frame, door and windshield structure 37, which is large enough to be fitted with reinforcing aircraft fuselage struts and supports 47, 48, 49, 50, slender tempered glass panes 51, and 52, fitted between reinforcing fuselage struts and supports, and two triple monorail ejection devices FIG. 6, on each side of the aircraft one behind the other. FIG. 1 is a transparent side view of an aircraft fuselage, with two lateral ejection components FIG. 6, triple monorails, mounted on the supporting track launcher platform legs 9, in which the bottom tail fins are slotted. The aircraft fuselage has an emergency sliding door panel 34, tracks 30,31, an interior operational conventional hinge door 33, and an exterior sliding door arm 32, located near the lower right corner of the sliding emergency greater door panel. 46, and 46, are spring loaded latch catches attached to the fuselage frame on the sides of the aircraft to prevent the recoiling of the emergency sliding greater door panel into the lateral ejection path.

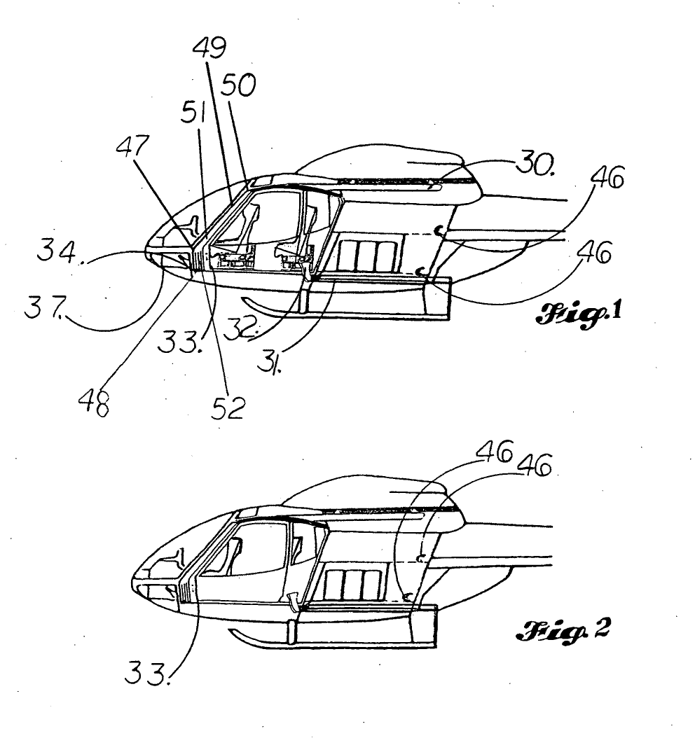

FIG. 2 is a side view of the reinforced and enlarged aircraft fuselage, with a closed fixed emergency greater sliding door panel 34, and interior operational conventional hinge door 33.

FIG. 3 is a side view of the aircraft fuselage 37, and closed fixed emergency greater sliding door panel 34, with interior operational conventional hinge door together transversing the aircraft fuselage by means of pneumatic rockets 35,36. FIG. 3 also shows a seat chassis 38, attached to a triple monorail ejection device or apparattii FIG. 6, during the ejection sequence when airbags 40, 41, and seat chassis, right side airbag 42, opens simultaneous with pneumatic rockets 35, 36 transversing the emergency greater sliding door panel to the rear of the fuselage, where spring loaded latch catches 46, and 46, are pushed by the sliding panel into a locked and rigid position.

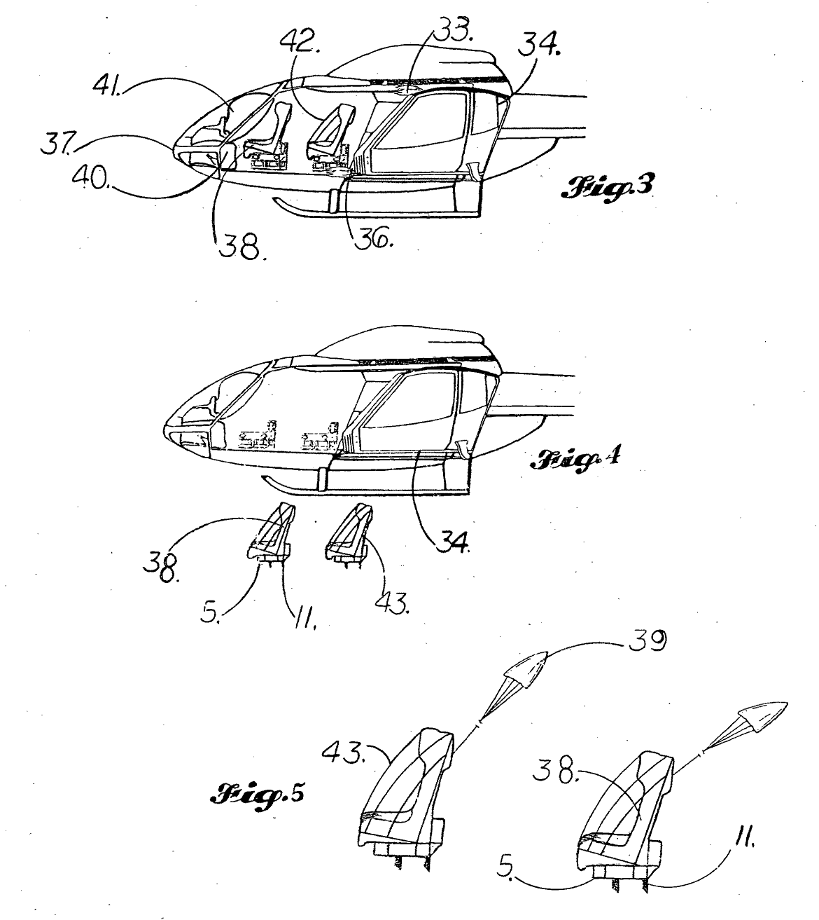

FIG. 4 is a side view of the path of the laterally ejecting apparattii 5, with attached seat chassis 38, after ejecting from the aircraft fuselage, and guided by a rocket catapult system towards clearing the tail of the aircraft with the assistance of bottom-mounted tail fins 11. Left side head, neck, spine and chest protector, pressure sensitive airbag 43, is shown with a right side pressure sensitive airbag 42, concealed behind it 43.

FIG. 5 is a side view of the laterally ejected devices initiating parachute extraction by means of a drogue chute 39, extraction, after the ejected apparattii have cleared the aircrafts debris. Similarly, to FIG. 4, FIG. 5 identifies a left side airbag 43, with a right side airbag 42, concealed behind.

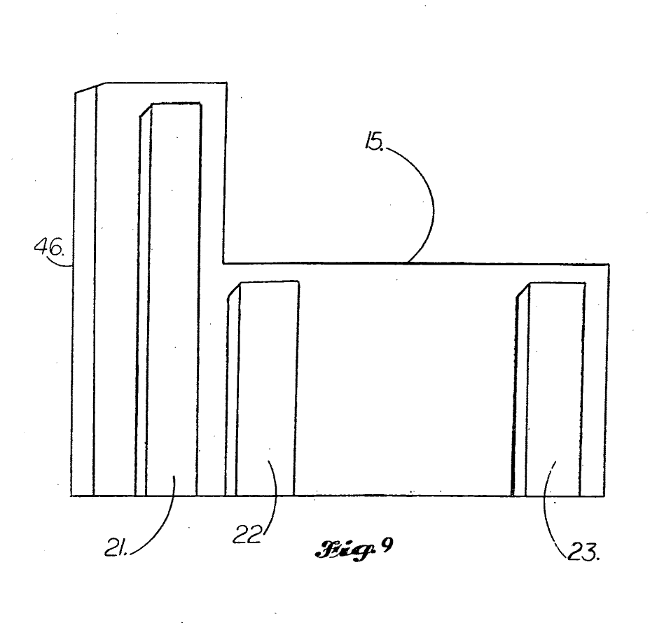

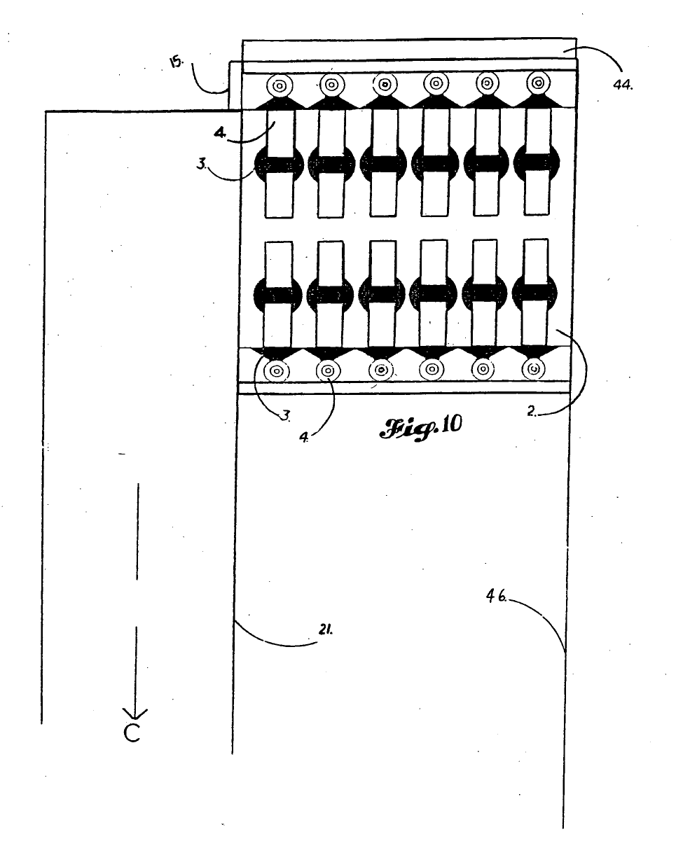

FIG. 6 is a side view of the triple monorail components of the triple monorail lateral ejection method, comprising two bottom monorails 1, and one monorail positioned at a right angle 2, to the bottom two monorails. Each monorail consists of wheel truck axle bases 3, and truck rollers 4. The monorails are surrounded by an outer track box 5, which is movable laterally along the triple monorails, and to which any seat frame, chassis or apparattii containing a passenger or occupant may be attached by means of a flange 44, located at the top interior corner of the outer track box; and by a drillable surface 45, on the outer track box at the center of the lower top section of the outer track box. When bolting or welding at the drillable area 45, one must leave room for a rocket catapult system 6, and 7, which is housed in the rectangular area between the bottom two monorails and directly below the drillable surface area 45. FIG. 6 clearly shows the support track 8, including the corner elbow joining abutment section 12, and the rubber knobs or runner 14, which seal these tracks from outside contact, along the edge of a tight Teflon of Teflon coated metallic mesh end cover 13, depicted partially and in transparency. The device further is supported on a launcher platform legs mold 9, a ceramic tile and alloy or metallic backed blast shield 10, seen partially in FIG. 6, and divided such that two bottom mounted tail fins 11, are slotted underneath the seat or apparattii within the platform legs mold. A area of circumference B, designates the angle theta, being the distance between the launcher platform legs in which the tail fins are slotted as the maximum angle theta the tail fins may exit the leg hole slots. 24, is a hermetically sealed sensor fuse box attached by a ripcord to both three parachutes and a blast shield. A rip cord cable 26, FIG. 15, opens a hermetic seal 25, of said sensor fuse box 24, upon separation of the apparattii and occupant from the aircraft fuselage during ejection. The tracks or rails may be mounted by bolts, molds or welding to any seat portal 38, and sighted to eject 90 degrees perpendicular to the horizontal longitudinal axis 38, and FIG. 1B, or, sighted along the angle 4 to 6 degrees preferred aft of the perpendicular in order to avoid a failed aircraft roll FIG. 4; in accordance with the spirit of the lateral ejection objectives; again, depending upon area limitations imposed by existing aircraft occupancy design, the 90 degrees, right-angle can be the common alignment to the longitude of an aircraft fuselage structure. Bottom-mounted tail fins 11, attached perpendicular to the seat and track apparattii can be automatically turned to any angle theta B, which is the maximum angle theta B, the tail fins may turn and still exit the tail fin slots located within the ejecting seat launcher platform legs 9, and then rudder, steer or direct the lateral ejection apparattii into the trajectory the shortest distance to escaping, exiting or ejected from the life threatening aircraft field of debris FIG. 4 and FIG. 5. The circumventing roller trucks 3, insure stable ejection pitches during foreseen catastrophic rolls, spins or spin and roll movements, impacts and collisions of a failed aircraft, specifically including high-temperature conditions when a guide track moving along a guide rail 1B, 2B, 3B, has the probability of malfunction due to the friction resultant from the expansion of a metallic track and guide rail track against one another, after the addition of the high temperatures from fire caused by accident or a high intensity military conflict and enemy fire; therefore the circumventing roller truck system provides air channels in a grid formation FIG. 10, FIG. 11 and FIG. 12, inside the monorail track tubes, or in other words constructed with 126 roller trucks and 252 roller truck wheels, ventilation ducting cooling system air flow chamber system to prevent or minimize disablement of an ejection track caused by onboard fires and friction.

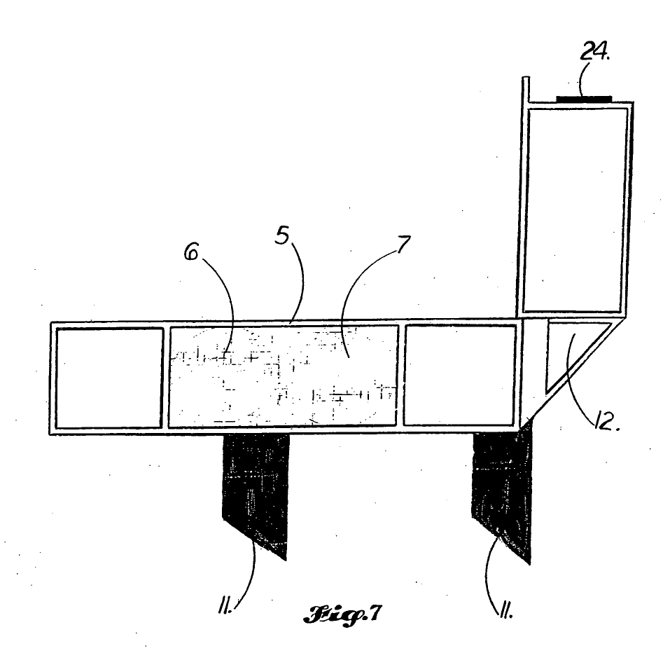

FIG. 7 is a side view of the triple monorails outer track ejection box 5, to which any seat or chassis can be mounted and then is movable along the inner tracks and supporting tracks. The corner elbow right angle abutment 12, attaches the lower portion of the outer track box to the upper portion back of seat, bed or apparattii of the outer track box. Both tail fins can be seen in FIG. 7, in an unslotted posture free form the launcher platform legs, while a rocket catapults system 6, and 7, are concealed behind a teflon mesh covered or teflon coated metallic mesh end cover.

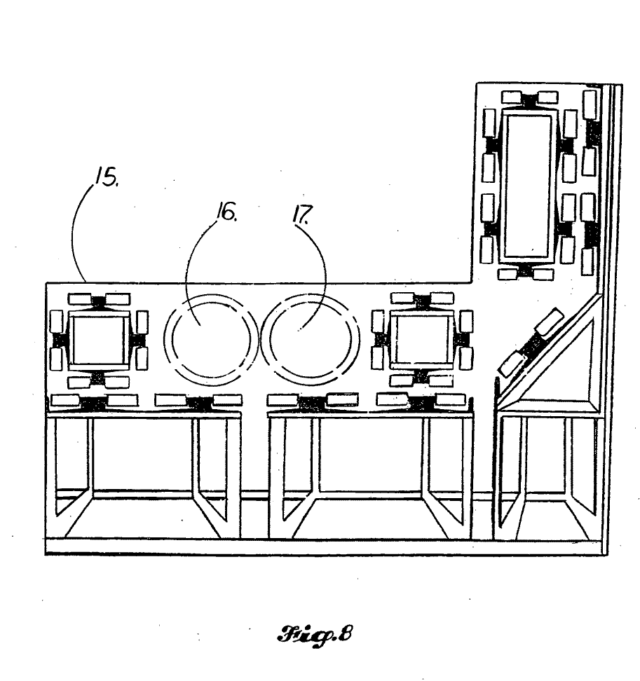

FIG. 8 is a side view of the triple monorails after the outer track box has been ejected, revealing the upper portion of a blast shield 15, and catapult rocket base seals 16, and 17, on a blast shield, and which base seals prevent the outer track box from moving or sliding on either the monorail inner tracks 1,2, or the support track 8. These two seals 16, and 17, are a failsafe locking mechanism which prevents the outer track box from moving prior to ejection, and which curved collar seals form a circle around the rocket catapult nozzle or nozzles, and said seals are burst by the exhaust of the rocket catapults and the combustion expansion within the seals which spring release this locking connection between the launcher platform base and the movable outer track box.

FIG. 9 is an interior side perspective view of the triple monorails, showing a blast shield 15, in its outline, and three monorail track support columns 21, 22, 23. 46E, is the back reinforcing panel of the launcher platform.

FIG. 10 is a transparent back view of the back monorail track 2, a cross sectional piece of a blast shield 15, and roller truck wheel bases 3, supporting roller truck wheels 4. FIG. 10, line C is a back side view of a back monorail track support column, 21, and FIG. 10 the back of the launcher platform mold covered by the back reinforcing panel 46E, of the launcher platform, and transparency of the back monorail track.

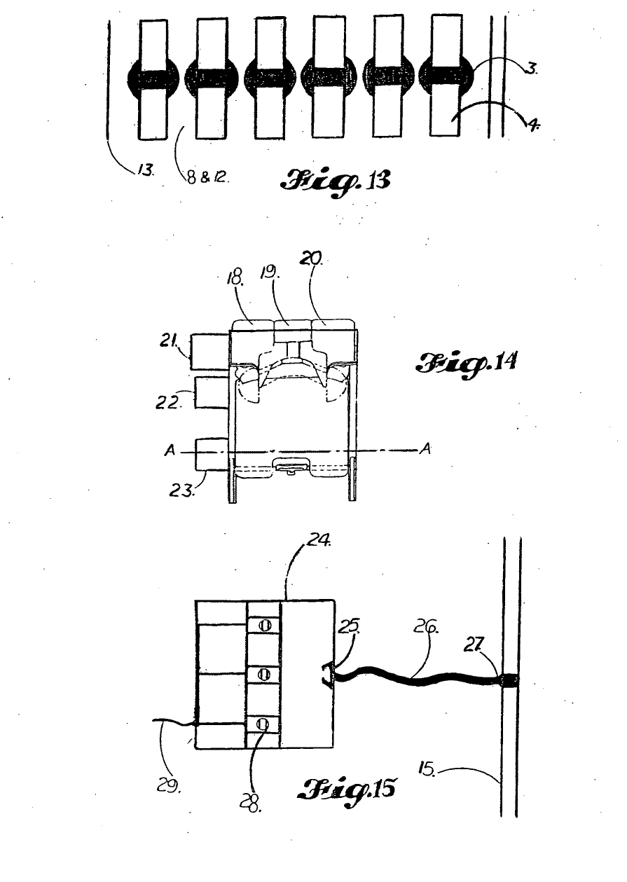

FIG. 11 is a transparent top view of one of the two bottom positioned monorail tracks 1, a cross sectional piece of a blast shield 15, a cross sectional of the mesh metallic end cover 13, roller truck bases 3, and roller truck wheels 4. Line A-A corresponds with line A-A of FIG. 14, and represents the positioning of the monorail track beneath the knee and thigh of a seat chassis occupant. 23 is a top view cross sectional piece of the bottom monorail track support column.

FIG. 12 is top view of the supporting track 8, roller trucks configuration 3, 4, which is identical to roller trucks 3, 4, design used on the inner monorail tracks 1. Also shown is a joining abutment between a blast shield 15, and the support track 8. FIG. 12, 23 shows how the support column 23, intersects a portion of the supporting track roller truck alignment, and the other portion of the supporting track roller trucks is aligned perpendicular to the horizontal longitude of a blast shield.

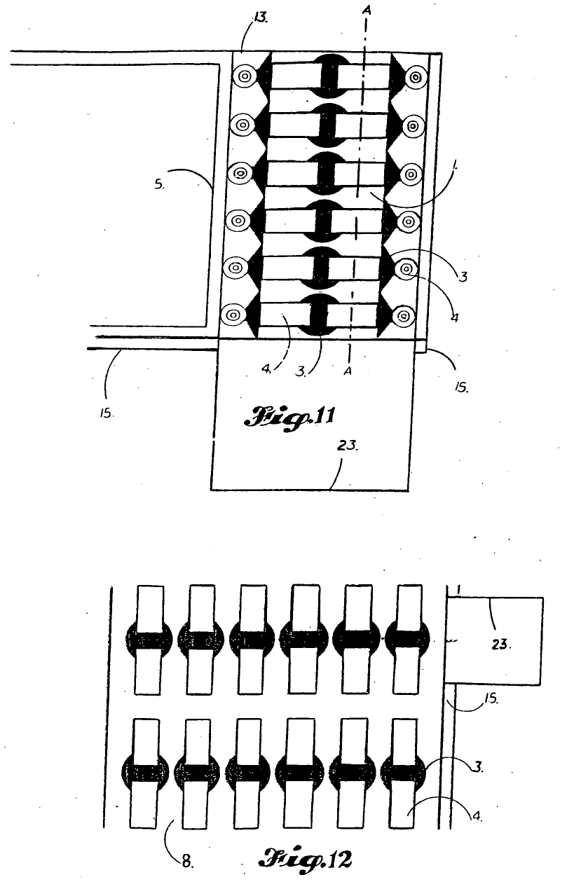

FIG. 13 is a top view of a corner elbow 12, of the launcher platform back section and bottom section triangle wedge adjoining abutment framework, supporting track 8, roller trucks configuration 3, 4, and a metallic mesh end cover 13.

FIG. 14 is a top view of an aircraft seat with three parachute cylinders 18, 19, 20, along the back of the seat chassis, inside the seats back framework. Line A-A is the position of the monorail track shown in FIG. 11, beneath the knee and thigh of a seat chassis occupant. 21, 22, 23, are top views of three inner monorail tracks support columns. At least three cylindrical compartments 18, 19, 20, which attach horizontally to the back of a seat chassis, inside the seat framework or chassis, contain three altitude appropriate parachutes with a hermetically sealed sensor fuse box 24, a failsafe and ambient pressure measuring device for countering the effects of electro-magnetic interference on the parachute deployment ignition; which controls the unique configuration and deployment of three parachutes with the third updraft, breaking and stabilizing parachute that facilitates fire, presence of liquid water, low or zero altitude ejections, counter acting the inertia forces of the occupant in the laterally ejected apparatus, when during a very low or zero altitude lateral ejection a seat or apparattii is not separated from the occupant FIG. 5, initially until a motor harness sequencing completes, except when liquid water is present, employing a gas powered rotor harness release; as when the seat separates from the occupant at higher altitudes in order to reduce the mass of the parachutist and therefore reduce the parachutist's rate of acceleration to a surface; rather, the seat FIG. 14, or bed chassis FIG. 1C, apparattii and side mounted airbags 42, and 43, are utilized along with a third smallest updraft, breaking and stabilizing parachute with circumvential swivel attachment to protect an occupant from the impact forces caused by a rocket catapult acceleration at very low or zero altitude along a trajectory the most lateral to an aircraft fuselage, forward motion/bearing and roll position of an aircraft fuselage when the emergency door is cleared from the lateral ejection pathway FIG. 3, for a lateral ejection at the instant of lateral ejection at very low or zero altitudes; since in many if not most examples of helicopters or planes where lateral ejection would be beneficial and life saving; such as in a zero altitude aircraft fire, when said aircraft is upright and not rolled onto its side FIGS. 1-4, and has reduced or minimal or zero bearing and the accelerating lateral ejection apparattii and occupant or occupants have the protective surfaces of the seat, bed, chassis, or apparattii and airbags FIG. 5, and the updraft, breaking and stabilizing parachute to protect the occupant or occupants body from abrasions, and direct impacts of surfaces into the human body.

FIG. 15 is a top transparent view of a hermetically sealed 25, altitude appropriate parachute ignition sensor fuse 28, box 24, which is connected to a blast shield 15, by a rip cord 26, and rip cord base 27, that pull a hermetic seal 25, from said sensor fuse box 24, upon lateral ejection of said apparattii from an aircraft. A sensor fuse box can be attached to a parachute system. 29 is an ignition wire for three altitude appropriate parachutes 18, 19, 20.

I claim for the patent letters:

33. Method for producing lateral ejection apparattii for helicopter or plane comprising, an aircraft fuselage with an interior guide track or rail system arranged perpendicular to the horizontal longitudinal axis of an aircraft fuselage, to which an aircraft seat framework, known as a, chassis or apparattii is attached and which apparatus or apparattii are rocket catapulted from an aircraft fuselage, by said means rocket catapult, so that a triple parachute configuration with a powered rotor motor harness and sensor fuse box with multiple sensors and fuses for activating the appropriate parachute based on ambient pressure can be deployed to recover an aircraft occupant;
two sets of dual airbags for positioning the legs and torso and protecting the head, neck, spine and organs of the ejecting occupant, necessary for safe lateral equal access emergency exit ejection;
three compartments for altitude appropriate parachutes, inside ejection rigid framework back;
a hermetically sealed fuse box with a rip cord attached to a blast shield in which altitude sensitive sensors and fuses for opening the desired altitude appropriate parachutes are contained; with a gas powered rotor motor harness which is useful and effective, not just at moderate and/or high or tolerable altitudes, but during onboard fires, runway overshooting, very low or zero altitudes, or when over a body of water at a very low or tolerable altitude; whenever a motor harness sequencing completes;
laterally ejecting apparattii at very low or zero altitudes, during aircraft fires, or water escape flotation, escapes that utilize a delayed seat, bed or apparattii separation from an occupant, using a gas powered rotor motor harness, so that the apparattii optionally controlled by a sequencing motor harness provides protective surfaces of a bed, seat, apparattii, flotation device located in a bed, seat or apparattii frame bottom or panel and/or airbags for the occupant as the laterally ejecting apparattii impacts the ground, water, air or other surface;
minimizing the lateral force on a spine, neck, head and organs of an occupant by either turning a seat or apparattii in a horizontal degree just prior to lateral ejection to reduce the vertical angle of the human body to the lateral force of a rocket catapult, including using side mounted pressure sensitive airbags or other concave, convex or bucket like restraints to create a rigid restraint and confine for the body, head, neck, spine and organs; or using any other bucket, convex or concave forms to restrain a human body during lateral ejection;
laterally ejectable apparattii which are aerodynamically able to navigate a life threatening aircraft debris field, by employing a track and guide rail construction of a monorail or monorails type, which uses a tubular airfoil form of monorail working as an airfoil or airfoils, i.e. wings, yaws, fins, flaps, rudders rotary positioned on the underside or underside and back of a lateral ejection apparattii, with air current flowing through the empty monorail track tube or tubes, insuring a steady and reliable emergence flight from said aircraft debris field;
a seat chassis able to eject laterally by the opening of an emergency pneumatic rocket propelled fixed greater sliding door panel, in which, a operational conventional hinged door is housed;
an emergency fixed greater sliding door panel with pneumatic rockets located at the top and bottom of the sliding panel, which door or panel is prevented from recoiling into the path of the ejecting occupant and device by spring loaded latch catches attached to the aircraft frame on the outside of a fuselage and pushed into a locked and rigid position by the pneumatic rocket propelled sliding emergency door or panel;
two sets of dual airbags for positioning the legs and torso and protecting the head, neck, spine and organs of the ejecting occupant, and which are mandatory for safe lateral equal access emergency exit ejection;
a anterior side mounted ceramic and alloy or metallic backed blast shield and track support to which a pair of ejection catapult rockets are sealed with collar seals around rocket nozzle ends, until ignited and bursting collar seals with rocket exhaust pressure, thereby preventing a track and seat chassis from moving along an inner and/or supporting track and guide rail, failsafe main-lock and ignition release key nozzle collar;
with a plane pneumatic rocket or other explosive charge method for a drop-down emergency panel or emergency door, and wing strut or support pneumatic removal or other said explosive charge means of wing strut, object or instrument removal from the emergency exit lateral ejection trajectory or pathway;
a track support launcher platform, column, columns or center console support the lateral ejection apparattii at a functional and comfortable level and height for the occupant or occupants;
an aircraft fuselage with a single and/or double track, track and guide rail system arranged perpendicular to the horizontal longitudinal axis of an aircraft interior;
in a single or double track construction, a number of rocket catapult chambers are used, which are correspondingly rocket catapult chambers, 1bb, 2bb and/or 3bb. Moreover the lateral ejection tool is sight-able by utilizing an aiming mechanism FIG. 1B, directed by a mechanized gear console handle 13B, and swing arm barrel sight seat swivel 14B for rotor positioning the occupant; only when existing fuselage area allows; actuated by cylindrical telescoping hydraulic arms 15B, and 16B, capable of realizing near perfect, or, perfect theoretical, lateral ejection respective of the real time forward motion (pressure) from velocity and position of a failed aircraft, by targeting preferred seat trajectories 9B, 10B, 11B, 12B, towards any quadrant within a sphere when right and left bipolar seat pairs FIG. 1B, are configured in a combat or high performance helicopter or plane; if said aiming mechanism operates independent of a robotic arm, which costs would perhaps become prohibitive except in luxury aircraft or military designs in an exemplary embodiment;
the aiming mechanism can work by pushing and pulling rotor positions on the lateral ejection track and guide rail with attached seat chassis, swinging from a center console 13B, containing a ceramic tile with alloy or metallic backing blast shield, and a swivel plate 14B, on which a single track, double track or triple monorail track are attached without overburdening the aircraft with additional weight; including attached simply to an aircraft floor or wall without a center console, riser or launcher platforms;
a seat chassis able to eject laterally by the opening of an emergency pneumatic rocket propelled fixed greater sliding door panel, in which, a operational conventional hinged door is housed;
an emergency fixed greater sliding door panel with pneumatic rockets located at the top and bottom of the sliding panel, which door or panel is prevented from recoiling into the path of the ejecting occupant and device by spring loaded latch catches attached to the aircraft frame on the outside of a fuselage and pushed into a locked and rigid position by the pneumatic rocket propelled sliding emergency door or panel;
two sets of dual airbags for positioning the legs and torso and protecting the head, neck, spine and organs of the ejecting occupant, necessary for safe lateral equal access emergency exit ejection;
three compartments for altitude appropriate parachutes, inside ejection rigid framework back;
a hermetically sealed fuse box with a rip cord attached to a blast shield in which altitude sensitive sensors and fuses for opening the desired altitude appropriate parachutes are contained; with a gas powered rotor motor harness which is useful and effective, not just at moderate and/or high or tolerable altitudes, but during onboard fires, runway overshooting, very low or zero altitudes, or when over a body of water at a very low or tolerable altitude; whenever a motor harness sequencing completes;
laterally ejecting apparattii at very low or zero altitudes, during aircraft fires, or water escape flotation, escapes that utilize a delayed seat, bed or apparattii separation from an occupant, using a gas powered rotor motor harness, so that the apparattii optionally controlled by a sequencing motor harness provides protective surfaces of a bed, seat, apparattii, flotation device located in a bed, seat or apparattii frame bottom or panel and/or airbags for the occupant as the laterally ejecting apparattii impacts the ground, water, air or other surface;
minimizing the lateral force on a spine, neck, head and organs of an occupant by either turning a seat or apparattii in a horizontal degree just prior to lateral ejection to reduce the vertical angle of the human body to the lateral force of a rocket catapult, including using side mounted pressure sensitive airbags or other concave, convex or bucket like restraints to create a rigid restraint and confine for the body, head, neck, spine and organs; or using any other bucket, convex or concave forms to restrain a human body during lateral ejection;
laterally ejectable apparattii which are aerodynamically able to navigate a life threatening aircraft debris field, by employing a track and guide rail construction of a monorail or monorails type, which uses a tubular airfoil form of monorail working as an airfoil or airfoils, i.e. wings, yaws, fins, flaps, rudders rotary positioned on the underside or underside and back of a lateral ejection apparattii, with air current flowing through the empty monorail track tube or tubes, insuring a steady and reliable emergence flight from said aircraft debris field;
a seat chassis able to eject laterally by the opening of an emergency pneumatic rocket propelled fixed greater sliding door panel, in which, a operational conventional hinged door is housed;
an emergency fixed greater sliding door panel with pneumatic rockets located at the top and bottom of the sliding panel, which door or panel is prevented from recoiling into the path of the ejecting occupant and device by spring loaded latch catches attached to the aircraft frame on the outside of a fuselage and pushed into a locked and rigid position by the pneumatic rocket propelled sliding emergency door or panel;
two sets of dual airbags for positioning the legs and torso and protecting the head, neck, spine and organs of the ejecting occupant, and which are mandatory for safe lateral equal access emergency exit ejection;
a anterior side mounted ceramic and alloy or metallic backed blast shield and track support to which a pair of ejection catapult rockets are sealed with collar seals around rocket nozzle ends, until ignited and bursting collar seals with rocket exhaust pressure, thereby preventing a track and seat chassis from moving along an inner and/or supporting track and guide rail, failsafe main-lock and ignition release key nozzle collar;
with a plane pneumatic rocket or other explosive charge method for a drop-down emergency panel or emergency door, and wing strut or support pneumatic removal or other said explosive charge means of wing strut, object or instrument removal from the emergency exit lateral ejection trajectory or pathway;
a track support launcher platform, column, columns or center console support the lateral ejection apparattii at a functional and comfortable level and height for the occupant or occupants;
an aircraft fuselage, with a, or, a set of seat chassis' mounted on triple monorails, and covered along the guide track end by a teflon mesh or teflon coated metallic mesh end cover;
a monorail supporting track;
an outer track, guide rail box to which any seat chassis or chassis' can be mounted, and ejected laterally, perpendicular to the horizontal longitudinal axis of an aircraft, and guided out of the path of a failed aircraft during ejection flight by two bottom rotor positioning tail fins slotted within the ejection monorails launcher platform legs mold, which fins or rudders at angle theta exit launcher platform leg slots, which is the maximum angle bottom-mounted tail fins can be turned and still exit the launcher platform leg slots;
laterally ejectable apparattii which are aerodynamically able to navigate a life threatening aircraft debris field, by employing a track and guide rail construction of a monorail or monorails type, which uses a tubular airfoil form of monorail working as an airfoil or airfoils, i.e. wings, yaws, fins, flaps, rudders rotary positioned on the underside or underside and back of a lateral ejection apparattii, with air current flowing through the empty monorail track tube or tubes, insuring a steady and reliable emergence flight from said aircraft debris field;
a seat chassis able to eject laterally by the opening of an emergency pneumatic rocket propelled fixed greater sliding door panel, in which, a operational conventional hinged door is housed;
an emergency fixed greater sliding door panel with pneumatic rockets located at the top and bottom of the sliding panel, which door or panel is prevented from recoiling into the path of the ejecting occupant and device by spring loaded latch catches attached to the aircraft frame on the outside of a fuselage and pushed into a locked and rigid position by the pneumatic rocket propelled sliding emergency door or panel;
two sets of dual airbags for positioning the legs and torso and protecting the head, neck and chest of the ejecting occupant, and which are mandatory for safe lateral equal access emergency exit ejection;
three compartments for altitude appropriate parachutes inside ejection rigid framework back;
a hermetically sealed fuse box with a rip cord attached to a blast shield in which altitude sensitive sensors and fuses for opening the desired altitude appropriate parachutes are contained; with a gas powered rotor motor harness which is useful and effective, not just at moderate and/or high or tolerable altitudes, but during onboard fires, runway overshooting, very low or zero altitudes, or when over a body of water at a very low or tolerable altitude; whenever a motor harness sequencing completes;
laterally ejecting apparattii at very low or zero altitudes, during aircraft fires, or water escape flotation, escapes that utilize a delayed seat, bed or apparattii separation from an occupant, using a gas powered rotor motor harness, so that the apparattii optionally controlled by a sequencing motor harness provides protective surfaces of a bed, seat, apparattii, flotation device located in a bed, seat or apparattii frame bottom or panel and/or airbags for the occupant as the laterally ejecting apparattii impacts the ground, water, air or other surface;
minimizing the lateral force on a spine, neck, head and organs of an occupant by either turning a seat or apparattii in a horizontal degree just prior to lateral ejection to reduce the vertical angle of the human body to the lateral force of a rocket catapult, including using side mounted pressure sensitive airbags or other concave, convex or bucket like restraints to create a rigid restraint and confine for the body, head, neck, spine and organs; or using any other bucket, convex or concave forms to restrain a human body during lateral ejection;
a seat chassis able to eject laterally by the opening of an emergency pneumatic rocket propelled fixed greater sliding door panel, in which, a operational conventional hinged door is housed;
an emergency fixed greater sliding door panel with pneumatic rockets located at the top and bottom of the sliding panel, which door or panel is prevented from recoiling into the path of the ejecting occupant and device by spring loaded latch catches attached to the aircraft frame on the outside of a fuselage and pushed into a locked and rigid position by the pneumatic rocket propelled sliding emergency door or panel;
two sets of dual airbags for positioning the legs and torso and protecting the head, neck, spine and organs of the ejecting occupant, and which are mandatory for safe lateral equal access emergency exit ejection;
a anterior side mounted ceramic and alloy or metallic backed blast shield and track support to which a pair of ejection catapult rockets are sealed with collar seals around rocket nozzle ends, until ignited and bursting collar seals with rocket exhaust pressure, thereby preventing a track and seat chassis from moving along an inner and/or supporting track and guide rail, failsafe main-lock and ignition release key nozzle collar;
with a plane pneumatic rocket or other explosive charge method for a drop-down emergency panel or emergency door, and wing strut or support pneumatic removal or other said explosive charge means of wing strut, object or instrument removal from the emergency exit lateral ejection trajectory or pathway;
a track support launcher platform, column, columns or center console support the lateral ejection apparattii at a functional and comfortable level and height for the occupant or occupants;
an aircraft fuselage, with a, or, a set of seat chassis' mounted on triple monorails, load bearing triple monorails with one-hundred twenty-six roller trucks and two-hundred fifty-two (or other number) of teflon or other fire resistant material coated, circumventing roller truck wheels attached to the inner rails monorail roller trucks grid, and a supporting track grid with forty-two roller trucks and eighty-four roller truck wheels (or other number);
a monorail supporting track;
an outer track, guide rail box to which any seat chassis or chassis' can be mounted, and ejected laterally, perpendicular to the horizontal longitudinal axis of an aircraft, and guided out of the path of a failed aircraft during ejection flight by two bottom rotor positioning tail fins slotted within the ejection monorails launcher platform legs mold, which fins or rudders at angle theta exit launcher platform leg slots, which is the maximum angle bottom-mounted tail fins can be turned and still exit the launcher platform leg slots;
laterally ejectable apparattii which are aerodynamically able to navigate a life threatening aircraft debris field, by employing a track and guide rail construction of a monorail or monorails type, which uses a tubular airfoil form of monorail working as an airfoil or airfoils, i.e. wings, yaws, fins, flaps, rudders rotary positioned on the underside or underside and back of a lateral ejection apparattii, with air current flowing through the empty monorail track tube or tubes, insuring a steady and reliable emergence flight from said aircraft debris field;
an ejection guide rail monorail roller truck and roller truck wheels construction, which is a self ventilating grid formation for ducting heat caused by fire or enemy fire, thereby said ventilating preventing or minimizing track freezing or similar failure of a guide track and rail system due to severe friction of metallic or alloy tracks, a track and guide rail expanding against one another from exposure to very high temperatures;
an emergency fixed greater sliding door panel with pneumatic rockets located at the top and bottom of the sliding panel, which door or panel is prevented from recoiling into the path of the ejecting occupant and device by spring loaded latch catches attached to the aircraft frame on the outside of a fuselage and pushed into a locked and rigid position by the pneumatic rocket propelled sliding emergency door or panel;
two sets of dual airbags for positioning the legs and torso and protecting the head, neck and chest of the ejecting occupant, and which are mandatory for safe lateral equal access emergency exit ejection;
three compartments for altitude appropriate parachutes;
a hermetically sealed fuse box with a rip cord attached to a blast shield in which altitude sensitive sensors and fuses for opening the desired altitude appropriate parachutes are contained; with a gas powered rotor motor harness which is useful and effective, not just at moderate and/or high or tolerable altitudes, but during onboard fires, runway overshooting, very low or zero altitudes, or when over a body of water at a very low or tolerable altitude; whenever a motor harness sequencing completes;
laterally ejecting apparattii at very low or zero altitudes, during aircraft fires, or water escape flotation, escapes that utilize a delayed seat, bed or apparattii separation from an occupant, using a gas powered rotor motor harness, so that the apparattii optionally controlled by a sequencing motor harness provides protective surfaces of a bed, seat, apparattii, flotation device located in a bed, seat or apparattii frame bottom or panel and/or airbags for the occupant as the laterally ejecting apparattii impacts the ground, water, air or other surface;
minimizing the lateral force on a spine, neck, head and organs of an occupant by either turning a seat or apparattii in a horizontal degree just prior to lateral ejection to reduce the vertical angle of the human body to the lateral force of a rocket catapult, including using side mounted pressure sensitive airbags or other concave, convex or bucket like restraints to create a rigid restraint and confine for the body, head, neck, spine and organs; or using any other bucket, convex or concave forms to restrain a human body during lateral ejection;
a seat chassis able to eject laterally by the opening of an emergency pneumatic rocket propelled fixed greater sliding door panel, in which, a operational conventional hinged door is housed;
an emergency fixed greater sliding door panel with pneumatic rockets located at the top and bottom of the sliding panel, which door or panel is prevented from recoiling into the path of the ejecting occupant and device by spring loaded latch catches attached to the aircraft frame on the outside of a fuselage and pushed into a locked and rigid position by the pneumatic rocket propelled sliding emergency door or panel;
two sets of dual airbags for positioning the legs and torso and protecting the head, neck, spine and organs of the ejecting occupant, and which are mandatory for safe lateral equal access emergency exit ejection;
a anterior side mounted ceramic and alloy or metallic backed blast shield and track support to which a pair of ejection catapult rockets are sealed with collar seals around rocket nozzle ends, until ignited and bursting collar seals with rocket exhaust pressure, thereby preventing a track and seat chassis from moving along an inner and/or supporting track and guide rail, failsafe main-lock and ignition release key nozzle collar;
with a plane pneumatic rocket or other explosive charge method for a drop-down emergency panel or emergency door, and wing strut or support pneumatic removal or other said explosive charge means of wing strut, object or instrument removal from the emergency exit lateral ejection trajectory or pathway;
a track support launcher platform, column, columns or center console support the lateral ejection apparattii at a functional and comfortable level and height for the occupant or occupants.

34. The method for producing lateral ejection bed apparattii for helicopter or plane comprising, a bed for sleeping, rest, or emergencies attached to long, perpendicularly arranged track, guide rail or apparattii rocket catapulted propelled laterally out of an aircraft fuselage interior by a rocket catapult system;
a monorail supporting track;
an outer track, guide rail box to which any bed chassis or chassis' can be mounted, and ejected laterally, perpendicular to the horizontal longitudinal axis of an aircraft, and guided out of the path of a failed aircraft during ejection flight by two bottom rotor positioning tail fins slotted within an ejection monorails launcher platform legs mold, which fins or rudders at angle theta exit launcher platform leg slots, which is the maximum angle bottom-mounted tail fins can be turned and still exit the launcher platform leg slots;
laterally ejectable bed apparattii which are aerodynamically able to navigate a life threatening aircraft debris field, by employing a track and guide rail construction of a monorail or monorails type, which uses a tubular airfoil form of monorail working as an airfoil or airfoils, i.e. wings, yaws, fins, flaps, rudders rotary positioned on the underside or underside and back of a lateral ejection bed apparattii, with air current flowing through the empty monorail track tube or tubes, insuring a steady and reliable emergence flight from said aircraft debris field;
an ejection guide rail monorail roller truck and roller truck wheels construction, which is a self ventilating grid formation for ducting heat caused by fire or enemy fire, thereby said ventilating preventing or minimizing track freezing or similar failure of a guide track and rail system due to severe friction of metallic or alloy tracks, a track and guide rail expanding against one another from exposure to very high temperatures;
an emergency fixed greater sliding door panel with pneumatic rockets located at the top and bottom of the sliding panel or door, which design is prevented from recoiling into the path of the ejecting occupant and bed device by spring loaded latch catches attached to the aircraft frame on the outside of a fuselage;
two sets of dual airbags for positioning the legs and torso and protecting the head, neck and chest of the ejecting occupant, necessary for safe lateral equal access emergency exit ejection;
three compartments for altitude appropriate parachutes;
a hermetically sealed fuse box with a rip cord attached to a blast shield in which altitude sensitive sensors and fuses for opening the desired altitude appropriate parachutes are contained; with a gas powered rotor motor harness which is useful and effective, not just at moderate and/or high or tolerable altitudes, but during onboard fires, runway overshooting, very low or zero altitudes, or when over a body of water at a very low or tolerable altitude; whenever a motor harness sequencing completes;
laterally ejecting bed apparattii at very low or zero altitudes, during aircraft fires, or water escape flotation, escapes that utilize a delayed bed apparattii separation from an occupant, using a gas powered rotor motor harness, so that the bed apparattii optionally controlled by a sequencing motor harness provides protective surfaces of a bed apparattii, flotation device located in a bed apparattii frame bottom or panel and/or airbags for the occupant as the laterally ejecting bed apparattii impacts the ground, water, air or other surface;
minimizing the lateral force on a spine, neck, head and organs of an occupant by using side mounted pressure sensitive airbags or other concave, convex or bucket like restraints to create a rigid restraint and confine for the body, head, neck, spine and organs; or using any other bucket, convex or concave forms to restrain a human body during lateral ejection;
a bed chassis able to eject laterally by the opening of an emergency pneumatic rocket propelled fixed greater sliding door panel, in which, a operational conventional hinged door is housed;
an emergency fixed greater sliding door panel with pneumatic rockets located at the top and bottom of the sliding panel, which door or panel is prevented from recoiling into the path of the ejecting occupant and bed device by spring loaded latch catches attached to the aircraft frame on the outside of a fuselage and pushed into a locked and rigid position by the pneumatic rocket propelled sliding emergency door or panel;
two sets of dual airbags for positioning the legs and torso and protecting the head, neck, spine and organs of the ejecting occupant, and which are mandatory for safe lateral equal access emergency exit ejection;
a anterior side mounted ceramic and alloy or metallic backed blast shield and track support to which a pair of ejection catapult rockets are sealed with collar seals around rocket nozzle ends, until ignited and bursting collar seals with rocket exhaust pressure, thereby preventing a track and seat chassis from moving along an inner and/or supporting track and guide rail, failsafe main-lock and ignition release key nozzle collar;
with a plane pneumatic rocket or other explosive charge method for a drop-down emergency panel or emergency door, and wing strut or support pneumatic removal or other said explosive charge means of wing strut, object or instrument removal from the emergency exit lateral ejection trajectory or pathway;
a track support launcher platform, column, columns or center console support the lateral ejection bed apparattii at a functional and comfortable level and height for the occupant or occupants;
with a single and/or double track, track and guide rail system arranged perpendicular to the horizontal longitudinal axis of an aircraft interior;
in a single or double track construction, a number of rocket catapult chambers are used, which are correspondingly rocket catapult chambers, 1bb, 2bb and/or 3bb. Moreover the lateral ejection tool is sight-able by utilizing an aiming mechanism FIG. 1B, directed by a mechanized gear console handle 13B, and swing arm barrel sight bed swivel 14B for rotor positioning the occupant; only when existing fuselage area allows; actuated by cylindrical telescoping hydraulic arms 15B, and 16B, capable of realizing near perfect, or, perfect theoretical, lateral ejection respective of the real time forward motion (pressure) from velocity and position of a failed aircraft, by targeting preferred bed trajectories 9B, 10B, 11B, 12B, towards any quadrant within a sphere when right and left bipolar bed pairs (or optional opposite directions of lateral ejection) FIG. 1B, are configured in a commercial, medical/emergency, combat or high performance helicopter or plane; if said aiming mechanism operates independent of a robotic arm, which costs would perhaps become prohibitive except in commercial, medical/emergency, luxury aircraft or military designs in an exemplary embodiment;
the aiming mechanism can work by pushing and pulling rotor positions on the lateral ejection track and guide rail with attached bed chassis, swinging from a center console 13B, containing a ceramic tile with alloy or metallic backing blast shield, and a swivel plate 14B, on which a single track, double track or triple monorail track are attached without overburdening the aircraft with additional weight; including attached simply to an aircraft floor or wall without a center console, riser or launcher platforms;
a bed chassis able to eject laterally by the opening of an emergency pneumatic rocket propelled fixed greater sliding door panel, in which, a operational conventional hinged door is housed;
an emergency fixed greater sliding door panel with pneumatic rockets located at the top and bottom of the sliding panel, which door or panel is prevented from recoiling into the path of the ejecting occupant and device by spring loaded latch catches attached to the aircraft frame on the outside of a fuselage and pushed into a locked and rigid position by the pneumatic rocket propelled sliding emergency door or panel;
two sets of dual airbags for positioning the legs and torso and protecting the head, neck, spine and organs of the ejecting occupant, necessary for safe lateral equal access emergency exit ejection;
three compartments for altitude appropriate parachutes, inside ejection rigid framework back;
a hermetically sealed fuse box with a rip cord attached to a blast shield in which altitude sensitive sensors and fuses for opening the desired altitude appropriate parachutes are contained; with a gas powered rotor motor harness which is useful and effective, not just at moderate and/or high or tolerable altitudes, but during onboard fires, runway overshooting, very low or zero altitudes, or when over a body of water at a very low or tolerable altitude; whenever a motor harness sequencing completes;
laterally ejecting apparattii at very low or zero altitudes, during aircraft fires, or water escape flotation, escapes that utilize a delayed bed apparattii separation from an occupant, using a gas powered rotor motor harness, so that the bed apparattii optionally controlled by a sequencing motor harness provides protective surfaces of a bed apparattii, flotation device located in a bed apparattii frame bottom or panel and/or airbags for the occupant as the laterally ejecting apparattii impacts the ground, water, air or other surface;
minimizing the lateral force on a spine, neck, head and organs of an occupant by either turning a bed apparattii using side mounted pressure sensitive airbags or other concave, convex or bucket like restraints to create a rigid restraint and confine for the body, head, neck, spine and organs; or using any other bucket, convex or concave forms to restrain a human body during lateral ejection;
laterally ejectable bed apparattii which are aerodynamically able to navigate a life threatening aircraft debris field, by employing a track and guide rail construction of a monorail or monorails type, which uses a tubular airfoil form of monorail working as an airfoil or airfoils, i.e. wings, yaws, fins, flaps, rudders rotary positioned on the underside or underside and back of a lateral ejection bed apparattii, with air current flowing through the empty monorail track tube or tubes, insuring a steady and reliable emergence flight from said aircraft debris field;
a bed chassis able to eject laterally by the opening of an emergency pneumatic rocket propelled fixed greater sliding door panel, in which, a operational conventional hinged door is housed;
an emergency fixed greater sliding door panel with pneumatic rockets located at the top and bottom of the sliding panel, which door or panel is prevented from recoiling into the path of the ejecting occupant and device by spring loaded latch catches attached to the aircraft frame on the outside of a fuselage and pushed into a locked and rigid position by the pneumatic rocket propelled sliding emergency door or panel;
two sets of dual airbags for positioning the legs and torso and protecting the head, neck, spine and organs of the ejecting occupant, and which are mandatory for safe lateral equal access emergency exit ejection;
a anterior side mounted ceramic and alloy or metallic backed blast shield and track support to which a pair of ejection catapult rockets are sealed with collar seals around rocket nozzle ends, until ignited and bursting collar seals with rocket exhaust pressure, thereby preventing a track and bed chassis from moving along an inner and/or supporting track and guide rail, failsafe main-lock and ignition release key nozzle collar;
with a plane pneumatic rocket or other explosive charge method for a drop-down emergency panel or emergency door, and wing strut or support pneumatic removal or other said explosive charge means of wing strut, object or instrument removal from the emergency exit lateral ejection trajectory or pathway;
a track support launcher platform, column, columns or center console support the lateral ejection bed apparattii at a functional and comfortable level and height for the occupant or occupants;
an aircraft fuselage, with a, or, a set of bed chassis' mounted on triple monorails, and covered along the guide track end by a teflon mesh or teflon coated metallic mesh end cover;
a monorail supporting track;
an outer track, guide rail box to which any bed chassis or chassis' can be mounted, and ejected laterally, perpendicular to the horizontal longitudinal axis of an aircraft, and guided out of the path of a failed aircraft during ejection flight by two bottom rotor positioning tail fins slotted within an ejection monorails launcher platform legs mold, which fins or rudders at angle theta exit launcher platform leg slots, which is the maximum angle bottom-mounted tail fins can be turned and still exit a launcher platform leg slots;
laterally ejectable bed apparattii which are aerodynamically able to navigate a life threatening aircraft debris field, by employing a track and guide rail construction of a monorail or monorails type, which uses a tubular airfoil form of monorail working as an airfoil or airfoils, i.e. wings, yaws, fins, flaps, rudders rotary positioned on the underside or underside and back of a lateral ejection apparattii, with air current flowing through the empty monorail track tube or tubes, insuring a steady and reliable emergence flight from said aircraft debris field;
a bed chassis able to eject laterally by the opening of an emergency pneumatic rocket propelled fixed greater sliding door panel, in which, a operational conventional hinged door is housed;
an emergency fixed greater sliding door panel with pneumatic rockets located at the top and bottom of the sliding panel, which door or panel is prevented from recoiling into the path of the ejecting occupant and device by spring loaded latch catches attached to the aircraft frame on the outside of a fuselage and pushed into a locked and rigid position by the pneumatic rocket propelled sliding emergency door or panel;
two sets of dual airbags for positioning the legs and torso and protecting the head, neck and chest of the ejecting occupant, and which are mandatory for safe lateral equal access emergency exit ejection;
three compartments for altitude appropriate parachutes inside ejection rigid framework back;
a hermetically sealed fuse box with a rip cord attached to a blast shield in which altitude sensitive sensors and fuses for opening the desired altitude appropriate parachutes are contained; with a gas powered rotor motor harness which is useful and effective, not just at moderate and/or high or tolerable altitudes, but during onboard fires, runway overshooting, very low or zero altitudes, or when over a body of water at a very low or tolerable altitude; whenever a motor harness sequencing completes;
laterally ejecting bed apparattii at very low or zero altitudes, during aircraft fires, or water escape flotation, escapes that utilize a delayed seat, bed or apparattii separation from an occupant, using a gas powered rotor motor harness, so that the apparattii optionally controlled by a sequencing motor harness provides protective surfaces of a bed apparattii, flotation device located in a bed apparattii frame bottom or panel and/or airbags for the occupant as the laterally ejecting bed apparattii impacts the ground, water, air or other surface;
minimizing the lateral force on a spine, neck, head and organs of an occupant by either turning apparattii using side mounted pressure sensitive airbags or other concave, convex or bucket like restraints to create a rigid restraint and confine for the body, head, neck, spine and organs; or using any other bucket, convex or concave forms to restrain a human body during lateral ejection;
a bed chassis able to eject laterally by the opening of an emergency pneumatic rocket propelled fixed greater sliding door panel, in which, a operational conventional hinged door is housed;
an emergency fixed greater sliding door panel with pneumatic rockets located at the top and bottom of the sliding panel, which door or panel is prevented from recoiling into the path of the ejecting occupant and device by spring loaded latch catches attached to the aircraft frame on the outside of a fuselage and pushed into a locked and rigid position by the pneumatic rocket propelled sliding emergency door or panel;
two sets of dual airbags for positioning the legs and torso and protecting the head, neck, spine and organs of the ejecting occupant, and which are mandatory for safe lateral equal access emergency exit ejection;
a anterior side mounted ceramic and alloy or metallic backed blast shield and track support to which a pair of ejection catapult rockets are sealed with collar seals around rocket nozzle ends, until ignited and bursting collar seals with rocket exhaust pressure, thereby preventing a track and seat chassis from moving along an inner and/or supporting track and guide rail, failsafe main-lock and ignition release key nozzle collar;
with a plane pneumatic rocket or other explosive charge method for a drop-down emergency panel or emergency door, and wing strut or support pneumatic removal or other said explosive charge means of wing strut, object or instrument removal from the emergency exit lateral ejection trajectory or pathway;
a track support launcher platform, column, columns or center console support the lateral ejection bed apparattii at a functional and comfortable level and height for the occupant or occupants;
an aircraft fuselage, with a, or, a bed chassis or set of bed chassis'mounted on triple monorails, load bearing triple monorails with two-hundred fifty-two roller trucks and three-hundred and four (or other number) of teflon or other fire resistant material coated, circumventing roller truck wheels attached to the inner rails monorail roller trucks grid, and a supporting track grid with eighty-four roller trucks and one-hundred-sixty-eight roller truck wheels (or other number);
a monorail supporting track;
an outer track, guide rail box to which any bed chassis or chassis' can be mounted, and ejected laterally, perpendicular to the horizontal longitudinal axis of an aircraft, and guided out of the path of a failed aircraft during ejection flight by two bottom rotor positioning tail fins slotted within an ejection monorails launcher platform legs mold, which fins or rudders at angle theta exit launcher platform leg slots, which is the maximum angle bottom-mounted tail fins can be turned and still exit the launcher platform leg slots;
laterally ejectable bed apparattii which are aerodynamically able to navigate a life threatening aircraft debris field, by employing a track and guide rail construction of a monorail or monorails type, which uses a tubular airfoil form of monorail working as an airfoil or airfoils, i.e. wings, yaws, fins, flaps, rudders rotary positioned on the underside or underside and back of a lateral ejection bed apparattii, with air current flowing through the empty monorail track tube or tubes, insuring a steady and reliable emergence flight from said aircraft debris field;
an ejection guide rail monorail roller truck and roller truck wheels construction, which is a self ventilating grid formation for ducting heat caused by fire or enemy fire, thereby said ventilating preventing or minimizing track freezing or similar failure of a guide track and rail system due to severe friction of metallic or alloy tracks, a track and guide rail expanding against one another from exposure to very high temperatures;
an emergency fixed greater sliding door panel with pneumatic rockets located at the top and bottom of the sliding panel, which door or panel is prevented from recoiling into the path of the ejecting occupant and device by spring loaded latch catches attached to the aircraft frame on the outside of a fuselage and pushed into a locked and rigid position by the pneumatic rocket propelled sliding emergency door or panel;
two sets of dual airbags for positioning the legs and torso and protecting the head, neck and chest of the ejecting occupant, and which are mandatory for safe lateral equal access emergency exit ejection;
three compartments for altitude appropriate parachutes;
a hermetically sealed fuse box with a rip cord attached to a blast shield in which altitude sensitive sensors and fuses for opening the desired altitude appropriate parachutes are contained; with a gas powered rotor motor harness which is useful and effective, not just at moderate and/or high or tolerable altitudes, but during onboard fires, runway overshooting, very low or zero altitudes, or when over a body of water at a very low or tolerable altitude; whenever a motor harness sequencing completes;
laterally ejecting bed apparattii at very low or zero altitudes, during aircraft fires, or water escape flotation, escapes that utilize a delayed bed apparattii separation from an occupant, using a gas powered rotor motor harness, so that the bed apparattii optionally controlled by a sequencing motor harness provides protective surfaces of a bed apparattii, flotation device located in a bed apparattii frame bottom or panel and/or airbags for the occupant as the laterally ejecting bed apparattii impacts the ground, water, air or other surface;
minimizing the lateral force on a spine, neck, head and organs of an occupant by either turning a seat or apparattii using side mounted pressure sensitive airbags or other concave, convex or bucket like restraints to create a rigid restraint and confine for the body, head, neck, spine and organs; or using any other bucket, convex or concave forms to restrain a human body during lateral ejection;
a bed chassis able to eject laterally by the opening of an emergency pneumatic rocket propelled fixed greater sliding door panel, in which, a operational conventional hinged door is housed;
an emergency fixed greater sliding door panel with pneumatic rockets located at the top and bottom of the sliding panel, which door or panel is prevented from recoiling into the path of the ejecting occupant and bed device by spring loaded latch catches attached to the aircraft frame on the outside of a fuselage and pushed into a locked and rigid position by the pneumatic rocket propelled sliding emergency door or panel;
two sets of dual airbags for positioning the legs and torso and protecting the head, neck, spine and organs of the ejecting occupant, and which are mandatory for safe lateral equal access emergency exit ejection;
a anterior side mounted ceramic and alloy or metallic backed blast shield and track support to which a pair of ejection catapult rockets are sealed with collar seals around rocket nozzle ends, until ignited and bursting collar seals with rocket exhaust pressure, thereby preventing a track and seat chassis from moving along an inner and/or supporting track and guide rail, failsafe main-lock and ignition release key nozzle collar;
with a plane pneumatic rocket or other explosive charge method for a drop-down emergency panel or emergency door, and wing strut or support pneumatic removal or other said explosive charge means of wing strut, object or instrument removal from the emergency exit lateral ejection trajectory or pathway;
a track support launcher platform, column, columns or center console support the lateral ejection bed apparattii at a functional and comfortable level and height for the occupant or occupants.

35. An aircraft fuselage for lateral ejection apparattii which is enlarged and has additional supporting aircraft fuselage struts and structural supports installed in the fuselage frame structure with slender tempered glass panes inserted between the reinforcing struts and structural supports added to the fuselage frame in order to accommodate the lateral ejection apparattii with the same near number of aircraft seats, and improved or near same field of view for the aircraft pilots, crew, passengers or other occupants;
which safe, stable and efficient process, methodology, devices and apparattii, may eject all occupants of aircraft, be they ejected from helicopters or planes, or, like action crossovers, such as gyroplanes or spacecraft designed to fly like planes, and are laterally ejected from an imperiled and life threatening said aircraft;
providing laterally aligned escape devices for all types of private, business, commercial, government and general aviation aircraft, which lateral ejection apparattii are stable, reliable, simple, efficient, safe and effective at extracting aircraft occupants from life threatening aircraft, whether they are sitting in a seat or lying down in a bed, or in an aircraft cabin or cockpit;
which method and process of escaping life threatening aircraft by lateral rocket catapult propulsion and a unique advanced triple (or number larger than 2) parachute configuration to extract pilots, passengers, emergency and medical patients in seats, beds or apparattii from life threatening aircraft by configuring rigid ejection apparattii framework perpendicular to aircraft longitudinal horizontal axis and propelling said occupant or occupants out the side of said aircraft by a rocket catapult system, past an emergency pneumatic rocket actuated sliding aircraft door or panel, wing strut, support or other propelled object in the lateral ejection pathway, so then an automatic parachute system can deploy, and lower or recover the laterally ejected occupant or occupants to the ground or surface;
with teflon or other fire resistant material, primarily on the outer surface, but not limited to the outer surfaces of a seat or bed or apparattii right and left side mounted, pressure sensitive airbags, and roller truck wheels, and track mesh end cover to prevent fire or enemy fire from burning or hitting the ejected occupant or occupants, or igniting the guide track or igniting the roller truck wheels;
such that an advantageous arrangement combining the advantages of conventional jet aircraft vertically seeking ejection apparatus with the advantages of lateral ejection apparattii and process is made possible;
such that rotor positioning apparattii and aircraft occupants for lateral ejection from an upright, rolled or rolling aircraft fuselage is possible;
when aircraft seats and their occupants can be aligned and usually are in commercial and private aircraft, along the edge of the planes right and left latitudes, and ejected laterally through the side wall, door, canopy openings or opening or space;
thereby, when an aircraft is in an upright posture minimizing both the applied force of gravity pulling down on the seat and seat occupant and distance, angle and altitude of recovery and time interval between rocket power ignition and rocket power off during the apparatus transversing from point A to point B;
so to be removed by the lateral ejection apparattii powered by a rocket catapult and moving from point A to point B along the same or near same gravitational plane along a preferred angle of descent and recovery when ejected laterally from a plane in a dangerous or life threatening descent;
so that an automatic, individual parachute system can be automatically activated and deployed to break and stabilize the plane occupant(s) descent to a surface, after ejecting laterally from a plane;
with separately falling seats and parachutists in aircraft that are laterally ejected perpendicular to the horizontal longitudinal axis of an aircraft fuselage in seat rows aligned in aisles on a reloading chain and gas engine powered track and guide rail lateral ejection apparattii are also constructed for laterally ejecting aircraft occupants who are arranged in rows and aisles.
